(19) United States
(12) Patent Application Publication
(10) Pub. No.: US 2017/0351786 A1
(43) Pub. Date: Dec. 7, 2017

(54) SCALABLE SPECTRAL MODELING OF SPARSE SEQUENCE FUNCTIONS VIA A BEST MATCHING ALGORITHM

(71) Applicant: Xerox Corporation, Norwalk, CT (US)

(72) Inventors: Ariadna Julieta Quattoni, Saint lsmier (FR); Xavier Carreras, Saint lsmier (FR); Matthias Gallé, Eybens (FR)

(73) Assignee: Xerox Corporation, Norwalk, CT (US)

(21) Appl. No.: 15/171,393

(22) Filed: Jun. 2, 2016

(51) Int. Cl. G06F 17/50; G06F 17/16

(52) U.S. Cl. CPC G06F 17/5009; G06F 17/16

(57) ABSTRACT

A method for modeling a sparse function over sequences is described. The method includes inputting a set of sequences that support a function. A set of prefixes and a set of suffixes for the set of sequences are identified. A sub-block of a full matrix is identified which has the full structural rank as the full matrix. The full matrix includes an entry for each pair of a prefix and a suffix from the sets of prefixes and suffixes. A matrix for the sub-block is computed. A minimal non-deterministic weighted automaton which models the function is computed, based on the sub-block matrix. Information based on the identified minimal non-deterministic weighted automaton is output.

### BACKGROUND

The exemplary embodiment relates to sequence modeling and finds particular application in connection with a system and modeling sparse sequence functions.

There are many cases in which it is desirable to model functions whose domains are discrete sequences over some finite alphabet, particularly when the functions are very sparse, meaning functions that have the property that only a very small proportion of the sequences in the domain map to a non-zero value. These sequences are referred to as the support of the function.

In Natural Language Processing (NLP) applications, for example, sparse sequence functions are often of special interest. For example, in language modeling, it may be useful to have an estimate of a probability distribution over sequences of symbols, such as characters or words. Language models are used as components in many applications, such as machine translation, speech recognition, hand-written recognition, and information retrieval. A language model can be regarded as a sparse function: Σ^{≦T}→ [symbol] , where the alphabet Σ consists of symbols that can be either characters or words and T is the maximum number of symbols in a sequence. Regardless of the alphabet used (i.e., characters or words) this function tends to be very sparse. For example, consider the possible characters sequences up to length 3 appearing in an English text. Out of the 26+26²+26³ possible character sequences, only a very small fraction constitute valid combinations (i.e., should have non-zero probability).

One useful function class over Σ^{≦}T is that of functions computed by non-deterministic weighted automata (NWA), since this class includes classes such as n-gram models and hidden Markov models. Several approaches have been proposed for estimating NWA that are based on representing the function computed by an NWA using a Hankel Matrix. (A. Beimel, et al., “Learning functions represented as multiplicity automata, J. ACM, 47(3), 506-530, 2000, hereinafter, Beimel 2000; H. Jaeger, “Observable operator models for discrete stochastic time series,” J. Neural Computation, Vol. 12, Issue 6, pp. 1371-1398 (2000); D. Hsu, “A spectral algorithm for learning Hidden Markov Models,” Proc. COLT, 2009 (hereinafter, Hsu 2009); Animashree Anandkumar, et al., “A method of moments for mixture models and Hidden Markov Models, CoRR 12, 2012; Borja Balle, et al., “Spectral learning of weighted automata: A forward-backward perspective,” Machine Learning, 2013, hereinafter, Balle 2013).

As an illustration of the method, consider the following problem: Assume that all the sequences in the support of some function over Σ^{≦T} are observed, where Σ represents an alphabet from which symbols forming the sequences are drawn and T is the maximum number of symbols in a sequence. and that the goal is to find the smallest NWA that reproduces that function. The spectral method could be implemented as follows. First, all the unique prefixes and suffixes of the support strings are computed. Second, a Hankel matrix is built in which each entry is the value of the target function on the sequence obtained by concatenating a prefix with a suffix. Third, Singular Value Decomposition (SVD) is performed on the matrix. Fourth, the SVD factorization is used to recover the parameters of the minimal NWA.

The computational cost of the algorithm is dominated by the SVD step (cost is in [symbol] (min(nₚ,nₛ)³), where nₚ and nₛ are the numbers of unique prefixes and suffixes. This cost can be reduced by using SVD algorithms that take advantage of the sparsity of H. The Sparse SVD (SSVD) approach often uses variations of the Lanczos algorithm (C. C. Paige, “The computation of eigenvalues and eigenvectors of very large sparse matrices,” The University of London Ph.D. Thesis, 1971; C. C. Paige, “Computational variants of the Lanczos method for the eigenproblem,” Int'l J. Maths Applics, 1972, hereinafter, Paige 1972). Another common approach to performing SVD on large matrices is based on sampling rows and columns of high norm sampling (A. Deshpande, et al., “Adaptive sampling and fast low-rank matrix approximation,” RANDOM 06, 2006, hereinafter, Deshpande 2006). Another approach is Randomized Projections (RP): In the context of Hankel based methods the dominant approach for dealing with large matrices has been to use SVD routines based on randomized projections (N. Halko, et al., “Finding structure with randomness: Stochastic algorithms for constructing approximate matrix decompositions,” SIAM review, 53(2), pp. 217-288, 2009, hereinafter, Halko 2009).

Even using such approaches, the size of H may grow exponentially with T and common algorithms for sparse SVD may prove too slow.

### INCORPORATION BY REFERENCE

The following reference, the disclosure of which is incorporated herein in its entirety, by reference is mentioned:

U.S. Pub. No. 20100198897, published Aug. 5, 2010, entitled DERIVING A FUNCTION THAT REPRESENTS DATA POINTS, by Can Evren Yarman describes deriving a function that represents data points by creating a Hankel matrix of an initial rank which contains the data points. Singular values are derived based on the matrix. If a particular singular value does not satisfy the error criterion, the rank of the matrix is increased until the particular singular value satisfies the error criterion, then values of parameters that approximate the function are computed.

### BRIEF DESCRIPTION

In accordance with one aspect of the exemplary embodiment, a method for modeling a sparse function over sequences includes inputting a set of sequences that support a function. A set of prefixes and a set of suffixes are identified for the set of sequences. A sub-block is identified having the full structural rank of a full matrix that includes an entry for each pair of a prefix and a suffix from the sets of prefixes and suffixes. A matrix is computed for the sub-block. A minimal non-deterministic weighted automaton which models the function is identified, based on the sub-block matrix. Information based on the identified minimal non-deterministic weighted automaton is output.

At least one of the steps of the method may be performed with a processor.

In accordance with another aspect of the exemplary embodiment, a system for modeling sparse functions over sequences includes a component which identifies a set of prefixes and a set of suffixes occurring in a set of sequences that support a function, a component which identifies a sub-block of a full matrix having the full structural rank of the full matrix, based on the sets of prefixes and suffixes, the full matrix including an entry for each pair of a prefix and a suffix, a component which computes a matrix for the sub-block, a component which identifies a minimal non-deterministic weighted automaton which models the function, based on the sub-block matrix, a component which outputs information based on the identified minimal non-deterministic weighted automaton, and a processor which implements the components.

In accordance with another aspect of the exemplary embodiment, a method for modeling a sparse function over sequences includes inputting a set of sequences that support a function, each sequence consisting of a set of symbols from an alphabet. A set of prefixes and a set of suffixes for the set of sequences are identified. A full Hankel matrix is computed which includes an entry for each pair of a prefix and a suffix from the sets of prefixes and suffixes. A bipartite graph is generated in which the prefixes form a first part and the suffixes form a second part. A longest path in the bipartite graph is computed by generating edges between vertices representing the prefixes and suffixes, the longest path connecting a first vertex in the first part with a second vertex in the second part. A set of best matching pairs is identified from the longest path. A sub-block of the full Hankel matrix is identified, based on the best matching pairs. A Hankel matrix is computed for the sub-block. A minimal non-deterministic weighted automaton which models the function is computed, based on the sub-block Hankel matrix, using singular value decomposition. Parameters of the minimal non-deterministic weighted automaton are computed.

At at least one of steps of the method may be performed with a processor.

### BRIEF DESCRIPTION OF THE DRAWINGS

FIG. 1 is a functional block diagram of a system for modeling a function over sparse sequences in accordance with one aspect of the exemplary embodiment;

FIG. 2 is a flow chart illustrating a method for modeling a function over sparse sequences in accordance with another aspect of the exemplary embodiment;

FIG. 3 illustrates a bipartite graph generated by the method of FIG. 2;

FIG. 4 illustrates a full Hankel matrix and a sub-block identified by Best Bipartite Matching;

FIG. 5 illustrates a bipartite graph with one match;

FIG. 6 illustrates a directed graph generated from the bipartite graph of FIG. 5;

FIG. 7 illustrates a directed graph from which two best matches can be obtained;

FIGS. 8 to 13 show average and standard deviation (over 10 iterations) of the time spent for a baseline method and the exemplary method where the x-axis is the number of sequences and the y-axis is the average time in seconds;

FIG. 14 shows reconstruction errors for character trigram expectations; and

FIG. 15 illustrates performance for character trigram acceptors.

### DETAILED DESCRIPTION

Aspects of the exemplary embodiment relate to a system and method for modeling sequence functions. The method is particularly useful in the case where these functions are sparse (that is, for most sequences they return 0). Particular focus is made on methods from the spectral family. These algorithms map the sequence modeling problem to a Hankel matrix H, and modeling is done via linear algebra operations. One of these entails computation of a singular value decomposition (SVD).

The exemplary method selects a subset of prefixes and suffixes of sequences that define an informative sub-block of H. In particular, the method finds a subset of rows and columns that define an informative sub-block of that matrix. The subset is selected by looking for a sub-block with full structural rank. The computation of that rank can be improved in the specific case of the Hankel matrix.

An efficient graph-based combinatorial algorithm to perform sub-block selection of large and sparse Hankel matrices is described herein. The method is shown to be significantly more efficient than existing approaches for scaling spectral methods for the estimation of minimal non-deterministic weighted automata (NWA).

As noted above, the method models a function whose domain is a collection of discrete sequences over some finite alphabet of symbols, such as words or letters. The function being modeled is a sparse function, by which it is meant a function that has the property that only a very small proportion of the sequences in the domain map to a non-zero value (the support of the function).

One specific application of the method is for solving problems arising in Natural Language Processing (NLP) applications, as discussed above, although the method is not limited to such applications.

In the exemplary method, the cost of the SVD step depends largely on the complexity of the support sequences, rather than on the size of the function's support. The complexity of the support sequences is a function of the number of states of the minimal NWA representation of the function. Put another way, estimating a function that can be computed by a 10 state NWA should much faster than estimating a function that is computed by a 10,000 state NWA.

### A Baseline Spectral Method

First, a conventional spectral method is described for recovering a minimal NWA representation of a target function.

First, the set P containing all the unique prefixes appearing in any sequence in the support of a function ƒ_{A}(x) is computed. The analogous set S containing all unique suffixes in any sequence in the support of the function ƒ_{A}(x) is computed.

Second, a Hankel matrix H∈ [symbol] ^{P|×|S|}, is computed. Each row in H is associated with a respective prefix p∈|P| and each column is associated with a respective suffix s∈|S|. The entries of the matrix are defined as follows: H(p,s)=ƒ_{A}(p·s) where p·s is the string obtained by concatenating p and s. If the concatenation operation results in a string longer than T (i.e., outside the domain of ƒ_{A}), the corresponding entry is defined as 0.

Third, for every symbol in the alphabet (σ∈Σ) a matrix H_{σ}∈ [symbol] ^{|P|×|S|} is computed, where H_{σ}(p,s)=ƒ_{A}(p·σ·s).

Fourth, the singular value decomposition of H is computed, i.e., H=ΛφΓ resulting in a matrix F=Λφ∈ [symbol] ^{|P|×m} and a matrix B=Γ∈ [symbol] ^{m×|s|}, where m is the numerical rank of H and H=FB is an m rank factorization of H.

Fifth, the parameters of the minimal NWA for ƒ_{A} are recovered (F⁺ and B⁺ are the pseudo-inverse of matrices F and B):
Transition Matrices: A_{σ}=F⁺H_{σ}B⁺
Starting vector: α₁=H(ε,:)B⁺, where ε denotes the empty symbol
Ending vector: α_{∞}=F⁺H(:,ε)

For further details on this method, see Balle 2013.

It has been observed that the number of states of any minimal NWA for ƒ_{A} is equal to the rank of H. This is sometimes referred to as the fundamental theorem of automata (see Beimel 2000) from which the basic spectral method is derived.

It can also be observed that a minimal NWA can be recovered from any P′⊂P, S′⊂S, provided that the rank of the corresponding Hankel sub-block defined by selecting the rows corresponding to prefixes in P′ and the columns corresponding to suffixes in S′ has the same rank as the complete H. That is, the rank of the sub-block should be m.

Thus in the ideal case, a full-rank sub-block H_{sub}∈ [symbol] ^{m×m} of H would be identified and then the complexity of the algorithm would only depend on m. Even if the ideal sub-block cannot be obtained, it would be advantageous to have an algorithm that produces a small and informative sub-block.

In fact, if such a sub-block is obtained, it is not necessary to compute the SVD decomposition, but rather define F=H and B=I and recover parameters: A_{σ}=H⁺H_{σ}, α₀=H(ε,:) and α_{∞}=H⁺H(:,ε).

However, for a given l by n matrix, finding a matrix subblock of size m by k of maximal rank is np-hard. See, R. Peeters, “The maximum edge biclique problem is NP-complete,” Discrete Applied Mathematics, 2003.

### Scalable Spectral Modeling Via a Best Bipartite Matching Algorithm (BBM)

The above spectral algorithm, in the context of finding the minimal NWA for an observed function, is essentially performing a reconstruction problem. Clearly, for practical applications, a learning scenario where the values obtained are either approximations of the function values, or the exact values but for only a subset of the support strings of the function would be sufficient. In either case, the learning problem is to recover a good approximation of the function.

In the following, a system and method are described for finding a small sub-block of H of high rank.

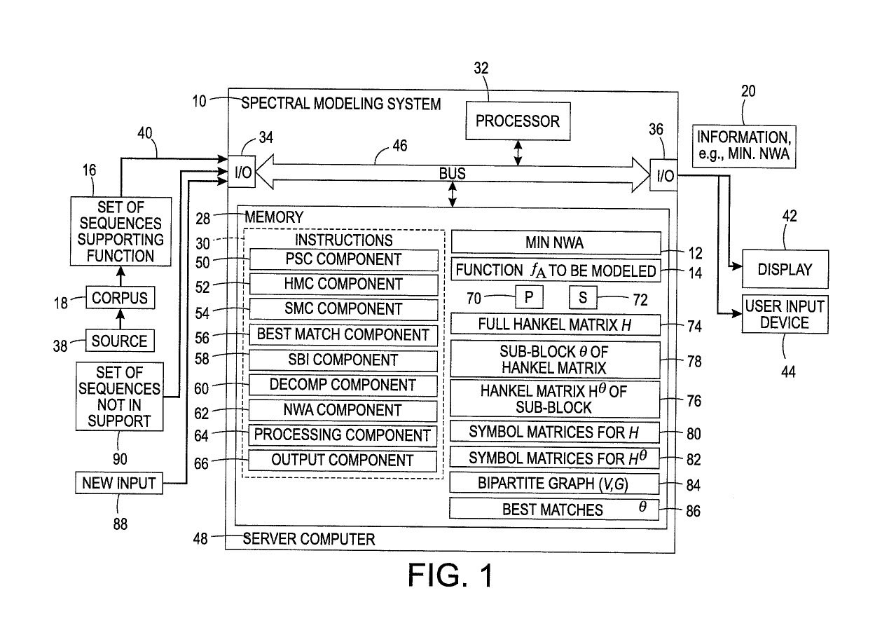

FIG. 1 is a functional block diagram of a computer-implemented spectral modeling system 10 for constructing a minimal NWA 12 which approximates an unknown function ƒ_{A} 14. The system 10 takes as input a set 16 of sequences forming the support of ƒ_{A}, e.g., sequences observed in a corpus 18. Each sequence includes a set of one or more symbols drawn from an alphabet. The system outputs parameters of the minimal NWA 12 that approximates the function ƒ_{A}, or other information 20 based thereon.

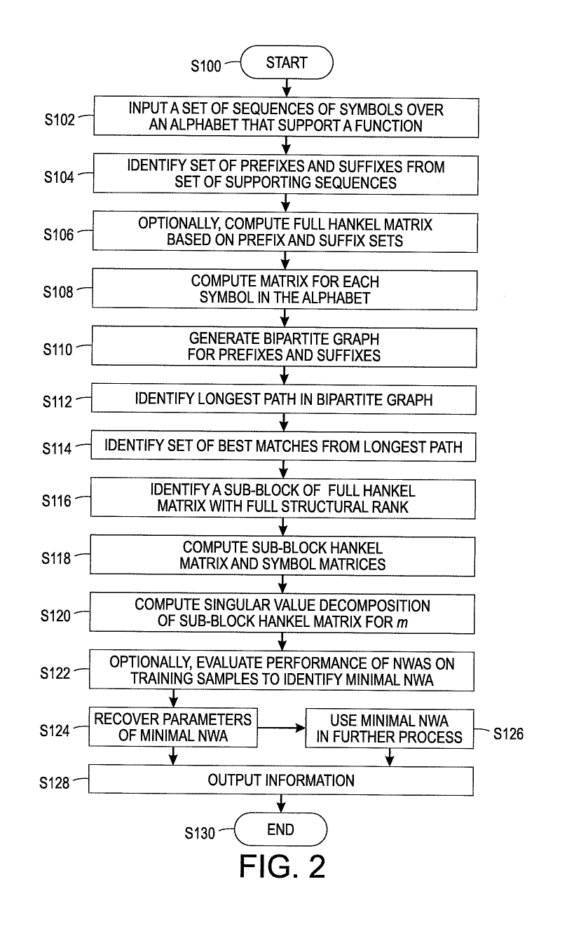

The system 10 includes memory 28, which stores software instructions 30 for performing the method illustrated in FIG. 2 and a processor 32, in communication with the memory, for executing the instructions. The system 10 also includes one or more input/output (I/O) devices, such as a network interface 34 and a user input output interface 36. The network interface 34 communicates with a source 38 of the sequences 16 (or the corpus 18, in the case where the sequences are identified by the system), such as a computing device or a memory storage device. Communication with the source may be via a wired or wireless link 40, such as a local area network or a wide area network, such as the Internet. The I/O interface 36 may communicate with one or more of a display 42, for displaying information to users, speakers, and a user input device 44, such as a keyboard or touch or writable screen, and/or a cursor control device, such as mouse, trackball, or the like, for inputting text and for communicating user input information and command selections to the processor device 34. The various hardware components 28, 32, 34, 36 of the system 10 may all be connected by a data/control bus 46. The system may be hosted by one or more computing devices, such as the illustrated server computer 48.

The instructions 32 include a prefix and suffix computation (PSC) component 50, a Hankel matrix computation component 52, a symbol matrix computation (SMC) component 54, a best match component 56, a sub-block identification (SBI) component 58, a decomposition component 60, an NWA component 62, an optional processing component 64, and an output component 66. These components are best understood with respect to the description of the method below. Briefly, the PSC component 50 identifies a set of all unique prefixes 70 and a set of all unique suffixes 72 in the sequences 16. The Hankel matrix computation (HMC) component 52 computes a full Hankel matrix 74 of the prefixes and suffixes. The same, or a different component, computes a Hankel matrix 76 for a selected sub-block 78 of the full Hankel matrix 74. The SMC component 54 computes a symbol matrix 80 for each symbol appearing in the full Hankel matrix. The same, or a different component, computes a symbol matrix 82 for the selected sub-block 78 of the full Hankel matrix 74. The best match component 56 generates a bipartite graph 84, which it uses to identify a set of best matches 86, each match composed of a prefix from the prefix set and a suffix from the suffix set, where each prefix and each suffix appears in no more than one match. The SBI component 58 selects the sub-block 78 of the Hankel matrix 74, based on the best matches 86. The decomposition component 60 performs singular value decomposition on the sub-block matrix 76. The NWA component 62 identifies the minimal NWA 12 for the matrix 76. The optional processing component 64 performs a process with the minimal NWA 12. For example, the processing component 64 may be a language model which takes as input a new sequence 88, and uses the NWA 12 to compute a probability that the new sequence (or a set of new sequences) comes from the same distribution as the input sequences 16. In another embodiment, the processing component serves as a classifier and uses the NWA 12 to predict whether or not the new sequence 88 comes from the same language at the input sequences 16. Other uses are described in the references cited herein. The output component 66 outputs information 20, such as the parameters of the minimal NWA, or information generated by the processing component.

The spectral modeling system 10 may include one or more computing devices 48, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 28 may represent any type of non-transitory computer readable medium such as random access memory (RAM), read only memory (ROM), magnetic disk or tape, optical disk, flash memory, or holographic memory. In one embodiment, the memory 28 comprises a combination of random access memory and read only memory. In some embodiments, the processor 32 and memory 28 may be combined in a single chip. Memory 28 stores instructions for performing the exemplary method as well as the processed data 70, 72, 74, 76, 78, 80, 82, 84, 86.

The network interface 34 and/or 36 allows the computer to communicate with other devices via a computer network, such as a local area network (LAN) or wide area network (WAN), or the internet, and may comprise a modulator/demodulator (MODEM) a router, a cable, and/or Ethernet port.

The digital processor device 32 can be variously embodied, such as by a single-core processor, a dual-core processor (or more generally by a multiple-core processor), a digital processor and cooperating math coprocessor, a digital controller, or the like. The digital processor 32, in addition to executing instructions 30 may also control the operation of the computer 48.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

With reference now to FIG. 2, a method for computing a minimal NWA which approximates a function is illustrated. The method begins at S100.

At S102, a set of sequences 16 that support a function 14 is provided (positive training examples). Sequences 90 that do not support the function may also be provided (negative training examples). A maximum sequence length T is input. A maximum number of states M in an NWA approximation may be specified.

At S104, for the set of sequences 16 that support a function, the set P 70 containing all the unique prefixes appearing in any sequence in the support of ƒ_{A}(x) is computed, by the PSC component 50. The analogous set S 72 containing all unique suffixes in any sequence in the support of ƒ_{A}(x) is computed.

At S106, a matrix 74, such as a Hankel matrix, may be computed, by the HMC component 52 based on the sets 70 and 72 of prefixes and suffixes. In practice, since the full Hankel matrix may be very large, it is not necessary to compute the full Hankel matrix, but only those elements which form the block identified at S116.

At S108, for every symbol in the alphabet (σ∈Σ) a respective symbol matrix 80 is computed, by the by the SMC component 54.

At S110, a bipartite graph 84 is generated, by the by the best match component 56, in which the vertexes (nodes) on one side (e.g., the left partition) correspond to prefixes in the prefix set 70 and the vertices on the other side (e.g., the right partition) correspond to suffixes in the suffix set 70.

At S112, an augmenting path procedure is performed on the graph 84 to identify a longest path, by the by the best match component 56. The procedure incrementally increases a number of edges in the bipartite graph that form a path connecting a first node which belongs to the left partition to a second node which belongs the right partition, and wherein the first and second nodes are as yet unmatched, until a longer path cannot be found.

At S114, a maximal set 86 of best matches is output, based on the augmented path, by the by the best match component 56. In the best matches, no node is connected to more than one other node.

At S116, a sub-block 76 of the full Hankel matrix 74 H with full structural rank is identified, by the SBI component 58. The sub-block is smaller in size than the full matrix. In particular, it is the minimum size sub-block of H which includes the rows and columns with entries corresponding to the best matches in the set 86.

At S118, a sub-block Hankel matrix 76 H^{θ} and respective symbol matrices 82 H_{σ}^{θ} are computed for the identified sub-block 78, by the HMC component 52 and SMC component 54, respectively. The sub-block has m rows and m columns, where m is the number of states in the minimal NWA.

At S120, a singular value decomposition of the sub-block Hankel matrix 76 H^{θ} is computed, by the decomposition component 60. This may include, decomposing the sub-block Hankel matrix 76 into two matrices using the value of m. In the case of a Hankel matrix, m corresponds to the number of columns (or rows) in the sub-block Hankel matrix 76.

At S122, where more than one NWA is computed, the minimal NWA 12 is identified by evaluating the NWA generated at S122 on training sequences to identify the one with the optimal performance.

At S124, the parameters of the minimal NWA A_{m*}^{θ*} that approximates the function ƒ_{A} are recovered, by the NWA component 62.

At S126, the minimal NWA 12 may be used in a further process, by the processing component 64.

At S128, information 20 is output, by the output component 66, such as the parameters of the minimal NWA, and/or information generated in the further process.

The method ends at S130.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 30, (for example, an internal hard drive of RAM), or may be separate (for example, an external hard drive operatively connected with the computer 30), or may be separate and accessed via a digital data network such as a local area network (LAN) or the Internet (for example, as a redundant array of inexpensive or independent disks (RAID) or other network server storage that is indirectly accessed by the computer 30, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 2, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Further details of the system and method are now provided.

### Input Sequences (S102)

It is assumed that a class of functions ƒ_{A} is defined over sequences 16 of discrete symbols, such as characters or words in the case of text. The aim is to find the function which best fits the sequences.

Let x=[x₁, . . . , xₜ] be a sequence of symbols over some finite alphabet Σ. The domain of the function consists of all sequences over Σ^{≦T}, i.e., of length less than or equal to a selected maximum sequence length T, where T is greater than 1. In some cases, there may be no limit placed on T. The support of the function is the set sequences 16 which give a non-zero value for the function, which includes the set of observed occurrences of x in a corpus 18. In the case of text, the corpus may be all text sequences up to length T generated from a document or set of documents (where the symbols may be concatenated to form a string). Other sequences can also be considered, such as biological sequences where the symbols are amino acids or the like.

The function ƒ_{A} to be modeled takes as input a sequence x of symbols drawn from the alphabet Σ and outputs a real number. In the case of text sequences, depending on the class of function, the real number can be, for example, the expected number of times that the sequence will appear in a text string, such as a sentence in a given language, or the probability of observing that sequence in the set of sequences, or the probability that the sequence is in a given language.

### Identifying Prefixes and Suffixes (S104)

For any sequence, sets 70, 72 of unique prefixes and suffixes exist, denoted P and S. A prefix includes up to the entire sequence, starting at the beginning, while the corresponding suffix includes the remainder, if any, of the sequence. Both the prefix and the suffix can be empty. For example, given the word sequence the red ball, the set of prefixes is (ε, the, the red, the red ball) and the set of suffixes is (the red ball, red ball, ball, ε), where ε denotes an empty prefix or suffix. For word sequences, the document(s) in the corpus may be preprocessed to remove non-words, such as punctuation and numbers. For character sequences, letters, gaps, punctuation, and numbers may all be considered as symbols.

### Non Deterministic Weighted Finite State Automaton

An m state NWA is defined as a tuple: A= [symbol] α₀,α_{∞},A_{σ} [symbol] , where α₀, α_{∞}∈ [symbol] ^{m} are initial and final weight vectors, respectively, and A_{σ}∈ [symbol] ^{m×m} are the |Σ| transition matrices which are associated with each symbol [symbol] σ [symbol] ∈Σ. The function ƒ_{A}:Σ^{≦T}→ [symbol] realized by a NWA is defined as:

ƒ_{A}(x)=α₀^{T}Aₓ_{₁} . . . Aₓ_{ₜ}α_{∞}. (1)

where T represents the transpose, and x₁, . . . xₜ are the symbols in the alphabet, such that Aₓ_{₁} is the transition matrix for the first symbol, and so forth.

Equation (1) is an algebraic representation of the computation performed by a NWA on a sequence x. To see this, consider a state vector sᵢ∈ [symbol] ^{m} where the jth entry represents the sum of the weights of all the state paths that generate the prefix x_{1:i} and end in state j. Initially, s₀=α₀, and then sᵢ^{T}=sᵢ₋₁^{T}Aₓ_{ᵢ} updates the state distribution by simultaneously emitting the symbol [symbol] xᵢ [symbol] and transitioning to generate the next state vector. NWAs constitute a rich function class which includes commonly used function classes such as functions computed by Hidden Markov Models (HMMs).

An NWA is said to be an acceptor if it computes a function: ƒ_{A}:Σ^{≦T}→{0,1}. Acceptors are essentially finite languages.

A spectral method is employed for recovering a minimal NWA representation for a target function ƒ_{A}. The estimation task to consider is the following: it is assumed that all the values of an unknown function ƒ_{A} over Σ^{≦}T are observed and that the goal is to find the minimal NWA that computes that function. By “minimal,” it is meant that there is no other NWA with less states that can compute the same function.

### Computing Full Hankel Matrix (S106)

A matrix 74, such as a Hankel matrix H∈ [symbol] ^{|P|×|S|}, is computed based on the sets 70 and 72 of prefixes and suffixes. The matrix H includes entries for all pairs of the prefixes and suffixes in sets P and S. In particular, each row in the full Hankel matrix H is associated with a respective prefix p∈|P| and each column is associated with a respective suffix s∈|S|. The entries of the matrix are defined as follows: H(p,s)=ƒ_{A}(p·s) where p·s is the string obtained by concatenating p and s. If the concatenation operation results in a string longer than T (i.e., outside the domain of ƒ_{A}), the corresponding entry is defined as 0.

### Computing Symbol Matrices (S108)

For every symbol in the alphabet (σ∈Σ) a respective symbol matrix 80 H_{σ}∈ [symbol] ^{|P|×|S|} is computed, where H_{σ}(p,s)=ƒ_{A}(p·σ·s), which is the concatenation of p, σ and s, unless the concatenation operation results in a string longer than T in which case the entry is 0.

Identifying a Sub-Block of the Full Hankel Matrix with Full Structural Rank (S110-S116)

The “structural rank” of a matrix is defined as the maximum numerical rank of all matrices with the same non-zero pattern. The structural rank of an m by k matrix A is thus defined as the maximum numerical rank of all matrices B so that if E(A)={c₁, . . . , cₗ} is a set listing all cells in matrix A with a value different from 0 then E(B)=E(A).

The exemplary method searches for a sub-block 78 θ of H with full structural rank, i.e., the same structural rank as H. It is not necessary to compute the structural rank of the Hankel matrix as the identified sub-block automatically has the full structural rank.

In the context of NWA and Hankel matrices, the structural rank can be interpreted as a measure of the complexity of the support of the function. This is because the structural rank of a Hankel matrix corresponds to the number of states of the minimal NWA for the hardest function defined over that support. The numerical rank of a matrix is the minimum number of vectors which, in combination, can be used to generate all the vectors (rows) of the matrix. The structural rank is an upper bound on the numerical rank. Thus, by definition, the numerical rank of a matrix is always less than or equal to its structural rank. Thus, the structural rank of the Hankel matrix H of a function ƒ_{A} will always be greater than or equal to the number of states of the minimal NWA computing ƒ_{A}. It can be shown that the chosen sub-block 78 has a good ratio of numeric rank versus size of sub-block.

The structural rank is always smaller than the size of the full Hankel matrix, and in the exemplary method, is generally quite close in size to the numerical rank.

### Generating a Bipartite Graph (S110)

The problem of finding a full structural rank sub-block of H can be cast as an instance of bipartite maximum cardinality matching. Given a bipartite graph (V,G) 84 where V are the set of vertices and G the set of edges, the maximum cardinality (best) matching is defined as the largest possible set of non-intersecting edges. “Non-intersecting” means that no two edges in the set of best matches share a common vertex.

In the case of the Hankel matrix for a function ƒ_{A}, a bipartite graph (V,G) is generated where on one side, the vertexes correspond to all the unique prefixes in the support of ƒ_{A}, and on the other side, the vertexes correspond to all unique suffixes, thus: |V|=|P|+|S|. There will be an edge connecting nodes i and j if the corresponding sequence made by the concatenation of prefix i and suffix j is in the support of ƒ_{A}, there is a non-zero entry in the Hankel matrix 74. Thus pairs of prefixes and suffixes that form the sequences in the set of sequences are each being connected by an edge, while other prefix-suffix pairs are not connected by edges. For every sequence s of length T in the support of ƒ_{A} and every possible cut of s into a prefix and a suffix, there will be T+1 corresponding edges in G, thus |G|=O(T|ƒ_{A}|) where |ƒ_{A}| is the number of sequences in the support of ƒ_{A}.

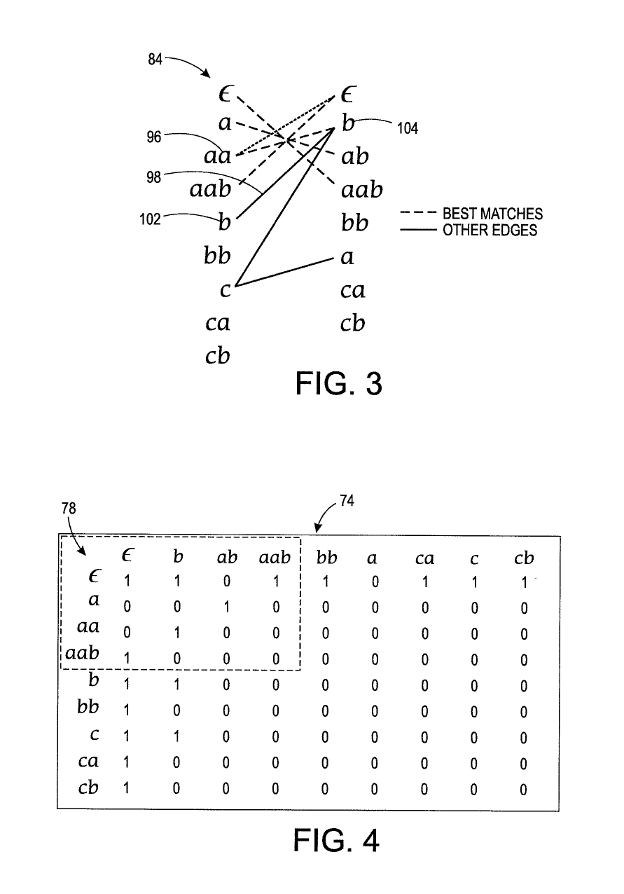

As an example consider a function ƒ_{A} of the form ƒ:Σ^{≦3}→ [symbol] , where Σ={a, b, c}. Suppose that the support 16 for the function is ƒ(aab)=1, ƒ(bb)=1, ƒ(ca)=1, ƒ(c)=1, ƒ(b)=1, ƒ(c,b)=1, ƒ(ε)=1, where ε denotes the empty symbol. The set of prefixes P={ε, aa, aab, b, bb, c, ca, cb} and the set of suffices S={ε, b, ab, aab, bb, a, ca, c, cb}. The corresponding bipartite prefix-suffix graph 84 is shown in FIG. 3. Edges 96, 98, etc., connect only those vertices 102, 104, etc. which have non-zero entries in the corresponding Hankel matrix 74, shown in FIG. 4.

### Identifying Longest Path in Bipartite Graph (S112)

Given a set of pairs of strings, where the first element denotes a prefix and the second a suffix, a maximum cardinality (best) is a subset of that set such that no two pairs share a common prefix or common suffix and there is no larger subset that satisfies that property.

As an example, in FIG. 3, the edges 96 and 98 (each representing a sequence) both share a common suffix (b) corresponding to vertex 104. Thus, the set of best matches cannot include both of these edges.

To find a maximum cardinality matching, a method is employed that is referred to as the augmenting path algorithms. Taking advantage of the structure of the Hankel matrix, improvements can be made to that method. Once a maximum cardinality matching is found, the sub-block of H is defined as the sub-block corresponding to all vertexes in the matching.

A maximum cardinality matching (best matches) for the graph in FIG. 3 is shown by the dashed lines. For ease of illustration, all edges from the empty prefix and suffix nodes are omitted, except for the ones in the best matching.

FIG. 4 shows the Hankel matrix 74 of the target function, and a corresponding Hankel sub-block θ 78 for the matching shown in FIG. 3. The structural rank of the sub-block 78 is equal to the number of edges in the best match (4 in this case). For the matrix shown,

rank(H)=structural_rank(H)=4

rank(H^{θ})=structural_rank(H^{θ})=4

### Identifying Longest Path (S112)

An augmenting path procedure is used for solving the (unweighted) maximum bipartite matching problem, which can be implemented in different ways.

1. General Augmenting Path Algorithm

In the augmenting path algorithm, each augmenting path increases the matching by one (regardless of the current matching). Also, a matching is maximal if and only if there is no augmenting path.

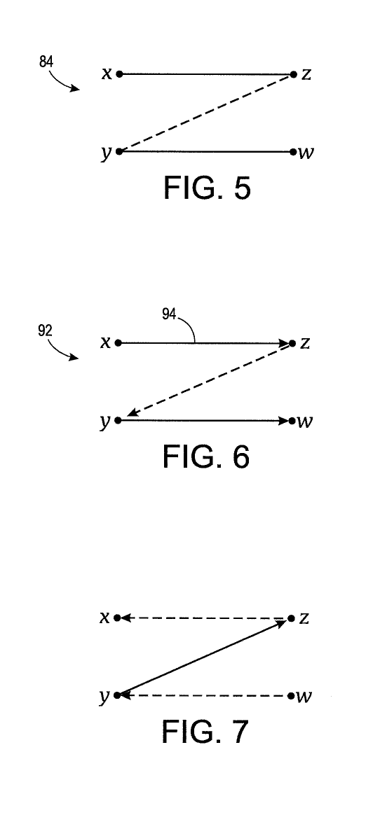

As an example, assume the instance illustrated in FIG. 5. Also assume that the current matching (not maximal) is as follows: M₁={(y,z)}. This is clearly not maximal, as a better (and maximal) matching would be {(x,z),(y,w)}. The augmenting path procedure maps the previous matching to a directed graph 92, denoted G, as illustrated in FIG. 6.

In the directed graph G, non-selected edges are directed from left to right, while selected edges are directed from right to left. An augmenting path 94 is then defined as a path x₁, . . . , xₙ over G, such that x₁ belongs to the left partition, xₙ to the right one, and both x₁ and xₙ are unmatched (this is, do not yet belong to a matching). No restrictions are put on the intermediate nodes, but it becomes clear that the path alternates between unmatched pairs (left to right edges) and matched pairs (right to left). Such paths can now be retrieved with a standard graph transversal. In one embodiment, a depth-first search is used, which may be faster on sparse graphs. Starting from node x, the following path 94 can then be retrieved: x,z,y,w, and the graph can then be rewired, as shown in FIG. 7.

No further augmenting paths exist here, and the best matching algorithm therefore finishes with the following maximal matching Mₘₐₓ: {(x,z),(y,w)}.

In one embodiment, the method includes applying the augmenting path procedure on each node, making that solution equivalent to the maximal flow algorithm. In another embodiment, the algorithm finds several augmenting paths per iteration (see John E. Hoperoft, et al., “An n̂5/2 algorithm for maximum matchings in bipartite graphs,” SIAM J. on Computing, 2(4):225-231, 1973, hereinafter, Hoperoft-Karp). In general, the simple algorithm works faster than Hoperoft-Karp. Other methods which run faster can be employed (see Joao C. Setubal, “Sequential and parallel experimental results with bipartite matching algorithms,” 1996).

In one embodiment, a simple heuristic technique can be used that takes into account structural knowledge given by the fact that the underlying matrix is a Hankel matrix, as described below.

2. Heuristic Technique Based on Structural Properties of Hankel Matrices

The specific case where the left part of the bipartite graph 84 is composed of prefixes and the right part is composed of suffixes creates some strong structural constraints. Notably:

Property 1: (pσ,s) is an edge in the graph iff (p,σs) is an edge.

Thus given the sequence aab, then if there is an edge between aa and b in the set of best matches, there is also an edge between a and ab in the set of best matches. That is, the edges of the bipartite graph denoting a Hankel matrix come from (possibly overlapping) groups of edges, each group originating in one of the support strings.

The method can take advantage of this structural knowledge to speed-up the maximum matching algorithm. First, the prefixes are sorted by their lengths. The augmenting path procedure is applied, starting from the longest prefix node. Each augmenting path procedure returns a set of edges R to be removed from the matching, and a set of edges A to be added to the matching. For each edge in A: (σ₁ . . . σₙ,s)∈A, all shifted pairs (σ₁ . . . σᵢ,σᵢ₊₁ . . . σₙs) are considered. Due to Property 1, each one of these pairs is an edge in the bipartite graph. Each such pair is checked, and if both nodes are unmatched they can both be added to the matching.

The use of the structural knowledge heuristic in the exemplary method can provide a speed-up of about 2 times. In this method, the sub-block selection algorithm has a linear dependency on T (the length of the longest sequence in the function's domain). By exploiting further properties of the Hankel structure and the structure in its corresponding graph representation the dependence on T may be reduced.

### Identifying Best Matches and Sub-Block of Hankel Matrix (S114, S116)

The best matches are simply the pairs of prefixes and suffixes of the edges output by the augmenting path algorithm. In the case of FIG. 3, these are the pairs (ε, aa), (a, ab), (aa, b), and (aab, ε). A sub-block 78 which includes all of the prefixes and suffixes is identified in the Hankel matrix, as illustrated in FIG. 4.

### Compute Hankel Matrix for Sub-Block of Hankel Matrix (S118)

The Hankel matrix H^{θ} 76 for the sub-block selected at S116 is computed in the same way as the full Hankel matrix, but in this case using only the prefixes and suffixes appearing in the sub-block.

Given a set of n training tuples TT={<x₁,ƒ(x₁)> . . . <xₙ,ƒ(xₙ)>ₙ}, where x is a sequence in Σ^{≦T} and ƒ(x) is a real number, the Hankel sub-block matrix H^{θ} is computed as follows:

1) List the unique set of prefixes appearing in any sequence in TT, this set is denoted P={p₁, . . . p_{|P|}}.

2) List the unique set of suffixes appearing in any sequence in TT, this set is denoted S={s₁, . . . s_{|S|}}.

3) Compute the Hankel matrix corresponding to P and S, i.e., a matrix H of size |P| by |S| where H(i,j)=ƒ(pᵢ·sⱼ), (where ·represents concatenation).

4) Run the best matching algorithm to obtain a subset of prefixes PS={p₁, . . . , p_{|PS|}} included in P and a subset of suffixes SS={s₁, . . . , s_{|SS|}} included in S.

5) Compute H^{θ} (which is a subblock of H), it is a matrix of size |PS| by |SS| defined as H^{θ}_{(i,j)}=ƒ(pᵢ,sⱼ).

### Compute Symbol Matrix for Sub-Block of Hankel Matrix (S118)

For every symbol in the alphabet (σ∈Σ) a respective symbol matrix 82 H_{σ}^{θ}∈ [symbol] ^{|P|×|S|} is computed, where H_{σ}^{θ}(p,s)=ƒ_{A}(p·σ·s).

This includes computing for every symbol in the alphabet Σ, the corresponding |PS| by |SS| matrix H_{σ}^{θ}, defined as H_{σ}^{θ}[i,j]=ƒ(pᵢ·σ·sⱼ), where (pᵢ·σ·sⱼ) is this the concatenation of p, σ and s, unless the concatenation operation results in a string longer than T in which case the entry is 0.

### Singular Value Decomposition of Hankel Matrix of Sub-Block of (S120)

An SVD of the chosen p by s Hankel sub-block H^{θ} 76 of H the sub-block Hankel matrix is performed to obtain a factorization H=UΣV, where U are the left singular vectors, Σ is a diagonal matrix, and V are the right singular vectors. Given a desired number of states: m, the SVD is truncated to obtain an m rank decomposition of the form H=UₜΣₜVₜ, where Uₜ is a p by m matrix, Σₜ is an m by m matrix, and Vₜ is an m by s. From the truncated decomposition, the matrix F=UₜΣₜ and the matrix B=Vₜ are computed. Naïve SVD or a sparse SVD (SSVD) can be used in this step.

If the aim of the method is reconstruction rather than learning, the SVD step can be omitted and the minimal NWA is then identified directly from the sub-block matrix.

### Identifying Minimal NWA (S122)

In the case where more than one NWA is computed (e.g., m is not known), then for each of the NWA generated at S122, the NWA is evaluated on the training samples to obtain a measure of performance. If negative training samples 90 are provided, the evaluation may include testing the NWA on the positive training samples 16 and the negative training samples to compute the F1 measure

$$( 2 \times ( \frac{precision \times recall}{precision + recall} ) ) .$$

otherwise the evaluation may consider only the positive samples 16 and measure recall. The NWA which gives the optimal performance is identified as the minimal NWA 12 for the function ƒ_{A}.

### Recovering Parameters of Minimal NWA (S124)

The parameters of the minimal NWA A_{m*}^{θ*} that approximate the function ƒ_{A} are recovered, e.g., as described in Balle 2013. Let F⁺ and B⁺ represent the pseudo-inverse of matrices F and B. Then:
Transition Matrices: A_{m*}^{θ*}=F⁺H_{σ}^{θ}B⁺, i.e., one transition matrix is computed for each symbol.
Starting vector: α₁=H^{θ}(ε,:)B⁺, where ε denotes the empty symbol
Ending vector: α_{∞}=F⁺H^{θ}(:,ε)

### Using Minimal NWA in a Further Process (S126)

As described above, this may include processing a new sequence 88 or sequences using the minimal NWA A_{m*}^{θ*} 12.

In one illustrative embodiment, the minimal NWA 12 is used to compute the expected number of times that a character (or word) n-gram appears in a corpus, such as a corpus of text documents. This can be used, for example, to provide n-gram statistics for a language model for use in machine translation.

In another illustrative embodiment, the minimal NWA 12 is used to recognize observed character n-grams, i.e., a function that outputs 1 for n-grams observed in a corpus and 0 for unobserved n-grams.

In another embodiment, the minimal NWA is used to determine whether a sequence is associated with a particular anomaly, such as a problem with a device.

While this algorithm focuses on the reconstruction scenario, i.e., finding a minimal NWA that reproduces a sparse observed sequence function, the same approach can be used in the learning case where the aim is to approximate a function from which only a subset of its values are observed. Simply applying the reconstruction method as it is to the learning setting can give results that are as good as existing methods while being significantly more efficient.

However, in another embodiment, the best bipartite matching algorithm could be specifically adapted for the learning case. In this embodiment, unseen samples can be viewed as a type of uncertainty over the nodes and edges of the graph. The method would then modify the best bipartite matching algorithm so that it can take the uncertainty into account.

Without intending to limit the scope of the exemplary embodiment, the following examples illustrate the validation of the method on a synthetic corpus and application of the method on an existing corpus.

### EXAMPLES

### Example 1: Comparison of Execution Time with Different Augmenting Path Algorithms

Making a theoretical analysis of the worst-case behavior of the exemplary method using the Augmenting Path Algorithm described herein is challenging. While each iteration of the algorithm is never worse than the baseline augmenting path method (it is assumed that the checks can be done in time [symbol] (|E|), assuming a bitset implementation of sets), it may sometimes be the case that none of the shifted pairs are free, and therefore the algorithm only adds computations without improving the matching.

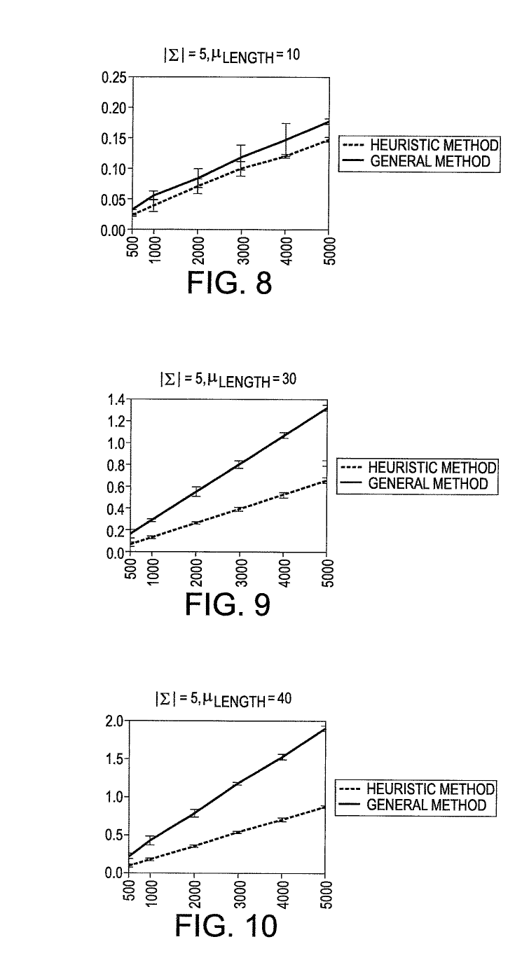

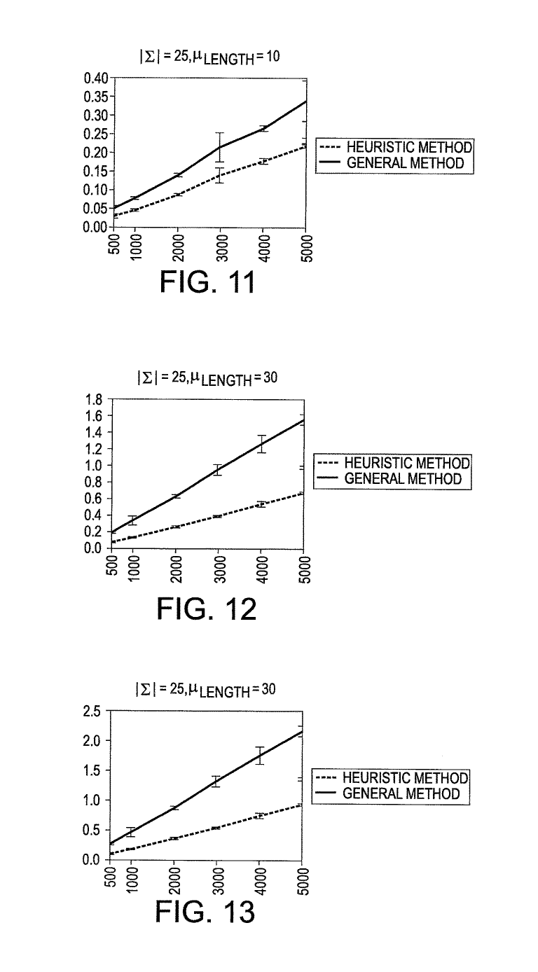

An empirical comparison of its execution time for the General Augmenting Path Algorithm and the Modified Algorithm considering heuristics was performed on synthetic data: Random strings were generated with different alphabet sizes, and different average length (by sampling from a Gaussian distribution with a variance of 0.5). The algorithms were implemented in the Python programming language. The respective times are plotted in FIGS. 8-13 for different alphabet sizes (|Σ|) and mean lengths (μ_{length}).

The solution is always better with the modified, heuristic method, with increased speed-up with increasing mean length (the average speed-up over all plots increases from 1.18 to 2.66), and with a smaller slope. Both the general and the modified implementations are probably sub-optimal. However, these results are expected to carry over to more sophisticated implementations, as any improvement will affect both versions (although not necessarily equally, as the general method runs the augmenting path procedure more often).

### Example 2

To validate the exemplary method on real data, experiments were performed on modeling the character-level distribution computed from English sentences appearing in the Penn TreeBank (PTB) corpus (see Mitchell P. Marcus, et al., “Building a large annotated corpus of English: The Penn TreeBank,” Computational Linguistics, 1993). In the reconstruction experiments, two problems are considered: 1) Finding the minimal NWA that computes the expected number of times that a character n-gram (a sequence of characters) appears in the corpus, and 2) Finding the minimal NWA that recognizes the observed character n-grams, i.e., a function that outputs 1 for observed n-grams and 0 for unobserved n-grams.

Experiments were performed with n-grams up to length three, i.e., learning a function ƒ:Σ^{≦3}→ [symbol] . The reason for choosing a relative small T is to be able to run the upper-bound (i.e., performing SVD on the complete Hankel matrix H, for comparison purposes) and the size of the corresponding Hankel matrix becomes unfeasible for larger n-grams. The present method is designed to handle that larger n-grams. This example focuses on a smaller T, since this setting already shows the increased efficiency of the method, and at the same time it allows running complete evaluations that require enumerating the full set of strings.

For these experiments, the modified version of bipartite matching discussed above was not employed, but rather, built-in optimized procedures of Matlab® programming. It should be noted that the data-sets here are much lower, due to the non-scalable nature of the benchmark algorithms.

Since the target function is the expected frequency of character trigrams, first, all sentences in the training portion of the PTB corpus are converted to character sequences. There are a total of 39,000 sentences, and the number of unique characters is |Σ|=75 (this alphabet includes letters, digits, punctuation and other symbols).

The first target function considered is the expected number of times that an n-gram up to length 3 will appear in a sentence sampled from the PTB corpus. That is:

$$f ( x ) = \frac{1}{\vert PTB \vert} {\sum }_{s ∈ PTB}^{ } g ( x , s )$$

where |PTB| is the number of sentences in the corpus and g(x,s) is a function that returns the number of times that n-gram x appears in sentence s. Since n-grams only up to length 3 are being considered, the size of the function domain is 75⁰+75¹+75²+75³=427,576.

The total number of n-grams with non-zero expectation is 21,613, thus the target function has a small support, since only 5% of the sequences in the domain have non-zero values. Since for this problem size, the rank of the complete Hankel matrix can be computed, the size of the minimal NWA can be computed, which for trigrams is 150. That means that an NWA with 150 states can compute the target function.

The second target function that is considered is a function that returns 1 for n-grams with non-zero expectation and 0 otherwise. This function is essentially an acceptor that recognizes a language over Σ^{≦3}. The size of the minimal NWA that computes the target is also 150. For the case of the acceptor the size of the smallest deterministic automaton that computes that function can also be determined. This can also be computed from the Hankel matrix (by the MyhillNerode theorem, this is equal to the number of unique rows of the Hankel Matrix) and the minimal number of states is 1,500.

Reconstruction Experiments

In this example, the Best Bipartite Matching Algorithm (BBM), described herein, for recovering the minimal NWA is compared to three alternative approaches: Sparse SVD (SSVD) (on the complete Hankel matrix), as described in Paige 1972, High Norm rows and columns (HN), as described in Deshpande 2006, and Randomized Projections (RP), as described in Halko 2009.

To measure performance, the l₁ distance between the function computed by the target automaton and the reconstructed automaton for the expectations target function is used. For the acceptor target function, performance is measured as

$$F 1 = 2 * \frac{( precision \times recall )}{precision + recall}$$

of the reconstructed automaton, with respect to the task of rejecting or accepting a sequence. Precision is the proportion of sequences that the reconstructed NWA accepted that are in fact sequences of the target language. Recall is the proportion of sequences in the target language that the reconstructed NWA accepted. In practice, for numeric reasons, the predictions are thresholded. Thus, the actual prediction of the reconstructed NWA is 1 if ƒ_{A}(x)>z and 0 otherwise. Results with respect to the optimal setting of the threshold z are obtained.

Performance is reported against the amount of computation time required to build the automaton. The computation time is composed of: (1) Time spent in selecting the Hankel sub-block (for algorithms that start by sub-block selection (e.g., best matching and high norm); plus (2) Time spent on computing the singular value decomposition; plus (3) Time spent computing matrix inverses to recover operators.

The HN method selects a Hankel sub-block by sampling rows and columns proportional to their norm. Thus a natural way of generating solutions that utilize different amounts of time is to vary the size of the sub-block. For RP, a sub-block is not selected. Instead, the Hankel matrix is projected to a lower dimensional space and then the singular value decomposition is performed on the projected matrix. Thus to get performance as a function of computational cost, the size of the projection can be changed.

Notice that all methods will perform SVD of a Hankel sub-block or a Hankel projection. Whenever SVD is computed, the cost of the most efficient routine (i.e., sparse or full SVD) is taken to be the cost of the algorithm. Another observation is that the SSVD algorithm takes as a parameter the number of singular values to compute. This is taken to be the minimum between the rank of the sub-block and the number of states of the minimal NWA for the target function. This is unrealistic, in the sense that the size of the minimal NWA would not normally be known. Thus the SSVD baseline is over-optimistic because in practice it may be necessary to ask for a larger number of singular values. All experiments were run on a 2.2 GHz Intel Core processor.

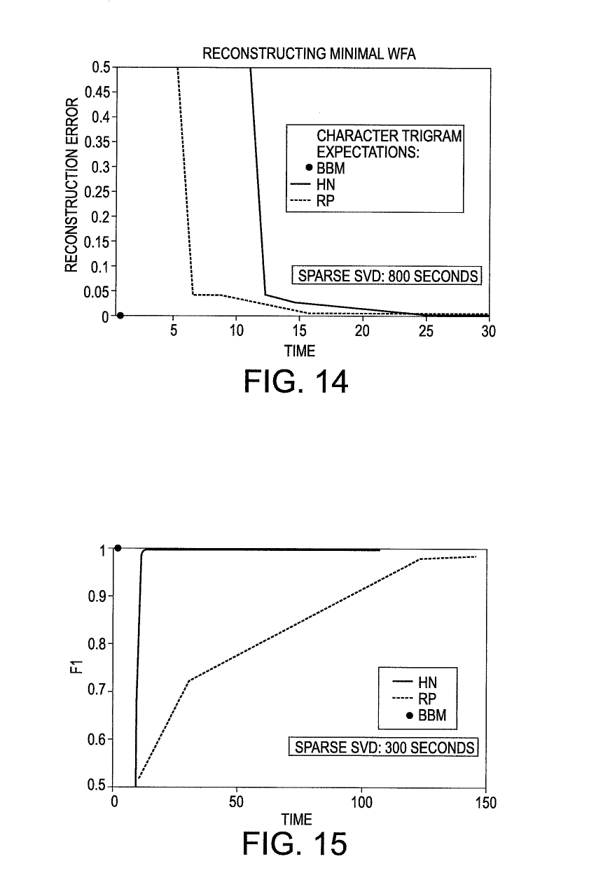

FIG. 14 shows performance for the expectations target function. SSVD takes 800 seconds while BBM is able to reconstruct the automaton in less than a second. Both HN and RP are significantly more efficient than SSVD. Still to get the perfect reconstruction, they are an order of magnitude slower than BBM.

Table 1 shows the size of the Hankel sub-blocks chosen by the HN and BBM methods, their corresponding rank and the cost of the SVD computation.

TABLE 1
Rank of the chosen Hankel Sub-block

| | Sub-block | Rank of | SVD Cost (in |
|---|---|---|---|
| Algorithm | Size | Sub-block | seconds) |
| BBM | 150 | 146 | 0.8 |
| HN | 10806 | 146 | 19 |
| HN | 5403 | 146 | 13 |
| HN | 2701 | 139 | 5 |
| HN | 1350 | 137 | 4 |
| HN | 675 | 124 | 1.4 |
| HN | 337 | 88 | 0.5 |
| HN | 168 | 65 | 0.1 |
| HN | 84 | 49 | 0.06 |
| HN | 42 | 40 | 0.01 |
| HN | 21 | 21 | 0.001 |

It can be seen that the speed up obtained by the best matching algorithm (BBM) comes from its ability of selecting a small Hankel sub-block of high rank.

FIG. 15 shows results when the target function is an acceptor (i.e., the function outputs 0 or 1) for recovering languages. It can be seen that in this case HN performs significantly better than RP. However, BBM is significantly more efficient.

Learning Experiments

For this set of experiments, the acceptor target function is focused on, but instead of considering a reconstruction problem, the performance of the different algorithms under a learning scenario is evaluated. More specifically, a setting is consider where a subset of the sequences in the support of the function is observed (these sequences are referred to as positive training samples) and a subset of sequences outside the support (these sequences are referred to as negative training samples). The goal is to learn an NWA so that it can predict if a novel test sequence is in the support of the target function or not. One possible objection to this learning setting is that it is assumed that there is no noise in the training sequences, i.e., if a positive sequence is observed it is assumed that the sequence must be in the target function. This is generally a reasonable scenario for the type of NLP applications of interest. Obviously some noise might be present in the data (e.g., coming from spelling errors in the n-gram acceptor case). However, the noise is expected to be minor and the main learning challenge does not arise from the noise in the data, but from the fact that only a fraction of the sequences observed is the function support.

To turn the reconstruction algorithms into learning algorithms approximations of the target function are computed with NWAs of increasing size. By running any of the reconstruction algorithms over the observed training sequences, the output will be a minimal NWA that accepts only those sequences. In other words, it will be an NWA that outputs 1 for all training sequences and 0 for any other sequence in the domain. Clearly this NWA would perform poorly since it will have a recall of 0, i.e., it will predict 0 for all unobserved positive test sequences.

The reconstruction algorithm is therefore modified so that some weight is given to unobserved sequences. This is done by finding an NWA with a smaller number of states that computes a function that is close to the function computed by the minimal NWA of the training sequences. It can be seen that by reducing the number of states of the NWA, the size of its support will be increased, i.e., increasing recall. Thus, the number of states of the NWA is considered as a regularization parameter which is validated using held-out sequences. The learning algorithm is illustrated in Algorithm 1.

Algorithm 1: Spectral Learning

```
Input:
  Positive Training Samples (i.e., samples in the support of the target
  function)
  Negative Training Samples (i.e., samples outside the support of the
  target function)
  M, maximum number of states in NWA approximation
  T, the maximum sequence length defining the function's domain.
Output:
  A*, an NWA that approximates the target function.
Algorithm:
  1: Partition the training data into two sets: S1 containing positive
  training sequences only and S2 containing positive and negative
  validation sequences.
  2: Using S1, compute matrices H and H_{σ} (as described for S106, S108)
  3: Select a Hankel sub-block θ and compute H^{θ} and H_{σ}^{θ} (as described
  for S110-S118).
  4: for m=1:M:
    4.1: Do truncated SVD and compute an m rank decomposition of H^{θ}
    (as described for S120).
    4.2: Compute NWA Aₘ^{θ} corresponding to the θ sub-block and m
    rank decomposition (as described for S124).
    4.3: Evaluate Aₘ^{θ} on S2 and let F1ₘ^{θ} be the obtained performance.
    (as described for S122).
  5: Let [symbol]   θ*,m* [symbol]   = arg min_{θ,m}F1ₘ^{θ} and return A* = Aₘ*^{θ}*.
```

It can be seen that Step 3 of Algorithm 1 will differ depending on the learning algorithm used. For SSVD over the complete Hankel, step 3 simply selects the complete Hankel. For HN this step selects k rows and columns, and it is run several times for different values of k. In the case of RP, a sub-block is not actually selected but instead the rows of H are projected into an l dimensional space. For BBM the best-matching sub-block is selected.

Thus RP and HN have an additional parameter to validate, namely the size of the sub-block k for the first one and the dimensionality of the projection l for the second one. When comparing the cost of the algorithms the additional cost incurred from having to validate an extra parameter is ignored. This is over-optimistic for randomized projections and HN but it eases the comparison with the other two methods. Also the cost of iterating over m is ignored. In practice it is generally feasible to run these validations in parallel. Similar to the reconstruction experiments when computing the F1 on the validation data, the prediction function is set to 0 if ƒ_{A}(x)≦z and 1 otherwise. The actual value of the threshold z is chosen using the validation data. Thus in practice, the actual final output of the algorithm is a tuple of [symbol] A_{*},z [symbol] of an NWA and a threshold which together define the prediction function.

For the computational cost comparison, focus is made on the cost of step 3 (only high norm and best-matching have a non-zero cost associated with this step) and the cost of 4.1 and 4.2 with respect to the optimal values of θ and m. More precisely, the total cost of a spectral learning algorithm is defined as the cost of the sub-block selection step plus the cost of 4.1 and 4.2 for the corresponding θ* and m*.

It can be seen that the spectral decomposition uses only positive samples, the negative samples are used only for model selection. Additionally, by considering a finite function domain (i.e. Σ^{≦T}) the target function is always in the function class since its Hankel has finite rank.

For the experiments in this section the 21,613 n-grams (up to length 3) appearing in the PTB corpus were partitioned into 15,000 n-grams used for training and 6,613 n-grams used for testing. Also, 100,000 negative training samples and 100,000 negative test samples were sampled. F1 performance on the test samples is shown in Table 2.

TABLE 2
Learning Experiments

| | | | | | | | Opt- |
|---|---|---|---|---|---|---|---|
| | | | | Opt- | Cost (in | Opt-Block- | Dim- |
| Algorithm | F1 | Prec | Recall | States | secs) | Size | Proj |
| SSVD | 62.07 | 65.12 | 59.29 | 15 | 110 | 10678-12568 | — |
| RP | 57.73 | 55.01 | 60.73 | 15 | 6.31 | 10678-12568 | 17 |
| HN | 58.41 | 62.02 | 55.19 | 5 | 0.3 | 400-400 | — |
| BBM | 58.12 | 61.22 | 55.32 | 5 | 0.04 | 148-148 | — |

It can be seen that all the conventional methods for scaling spectral learning and the proposed algorithm BBM perform comparably with respect to F1, but BBM is more than 2 orders of magnitude faster than RP and almost 1 order of magnitude faster than HN. At much higher computational cost (4 orders of magnitude), using all the information of the full Hankel does leads to better performance. This is consistent with recent theoretical results that suggest that (under some assumptions) using the complete observed Hankel is optimal with respect to generalization error.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for modeling a sparse function over sequences comprising:
inputting a set of sequences that support a function;
identifying a set of prefixes and a set of suffixes for the set of sequences;
identifying a sub-block of a full matrix, the sub-block having the full structural rank as the full matrix, the full matrix including an entry for each pair of a prefix and a suffix from the sets of prefixes and suffixes;
computing a matrix for the sub-block;
identifying a minimal non-deterministic weighted automaton which models the function, based on the sub-block matrix; and
outputting information based on the identified minimal non-deterministic weighted automaton,
wherein at least one of the computing of the full matrix, identifying the sub-block of the full matrix, identifying the minimal non-deterministic weighted automaton, and outputting information is performed with a processor.

2. The method of claim 1, wherein each of the input sequences includes a set of symbols drawn from an alphabet.

3. The method of claim 2 wherein the symbols in the alphabet comprise characters or words.

4. The method of claim 3, wherein the sequences are extracted from at least one text document.

5. The method of claim 1, wherein the full matrix is a Hankel matrix.

6. The method of claim 5, wherein the method includes inputting a maximum value of the number of symbols in a sequence.

7. The method of claim 1, wherein the identifying a sub-block of the full matrix comprises:
generating a bipartite graph in which the prefixes form a first part and the suffixes form a second part, pairs of prefixes and suffixes that form the sequences in the set of sequences each being connected by an edge;
computing a longest path in the bipartite graph along the edges, the longest path connecting a first vertex in the first part with a second vertex in the second part;
extracting a set of best matching pairs from the longest path that have no intersecting vertices; and
identifying the sub-block based on the best matching pairs.

8. The method of claim 1, wherein the computing a matrix for the sub-block comprises computing a Hankel matrix.

9. The method of claim 1, wherein the identifying a minimal non-deterministic weighted automaton based on the sub-block matrix comprises performing singular value decomposition on the sub-block matrix.

10. The method of claim 9, wherein performing singular value decomposition on the sub-block matrix comprises computing a non-deterministic weighted automaton for each of a set of singular values and identifying one of the non-deterministic weighted automata as the minimal non-deterministic weighted automaton based on performance.

11. The method of claim 1, wherein the method further includes extracting parameters of the minimal non-deterministic weighted automaton.

12. The method of claim 11, wherein the parameters include a starting vector, an ending vector and, for each symbol in the alphabet, a respective transition matrix.

13. The method of claim 1, wherein the information output includes parameters of the minimal non-deterministic weighted automaton.

14. The method of claim 1, further comprising implementing a process using the minimal non-deterministic weighted automaton and wherein the information output includes information generated in the process.

15. A system comprising memory which stores instructions for performing the method of claim 1 and a processor in communication with the memory for executing the instructions.

16. A computer program product comprising a non-transitory medium storing instructions which, when executed by a computer, perform the method of claim 1.

17. A system for modeling sparse functions over sequences comprising:
a component which identifies a set of prefixes and a set of suffixes occurring in a set of sequences that support a function;
a component which identifies a sub-block of a full matrix having the full structural rank of the full matrix, the full matrix including an entry for each pair of a prefix and a suffix from the sets of prefixes and suffixes;
a component which computes a matrix for the sub-block;
a component which identifies a minimal non-deterministic weighted automaton which models the function, based on the sub-block matrix;
a component which outputs information based on the identified minimal non-deterministic weighted automaton; and
a processor which implements the components.

18. The system of claim 17, further comprising a component which implements a process based on the minimal non-deterministic weighted automaton.

19. A method for modeling a sparse function over sequences comprising:
inputting a set of sequences that support a function, each sequence consisting of a set of symbols from an alphabet;
identifying a set of prefixes and a set of suffixes for the set of sequences;
generating a bipartite graph in which the prefixes form a first part and the suffixes form a second part;
computing a longest path in the bipartite graph by generating edges between vertices representing the prefixes and suffixes, the longest path connecting a first vertex in the first part with a second vertex in the second part;
extracting a set of best matching pairs from the longest path; and
identifying a sub-block based on the best matching pairs;
computing a Hankel matrix for the sub-block;
identifying a minimal non-deterministic weighted automaton which models the function, based on the sub-block Hankel matrix, using singular value decomposition; and
computing parameters of the minimal non-deterministic weighted automaton,
wherein at least one of the generating the bipartite graph, computing the longest path, extracting the set of best matching pairs, identifying the sub-block of the full Hankel matrix, identifying the minimal non-deterministic weighted automaton, and computing parameters is performed with a processor.
